(19) United States
(12) Patent Application Publication
(10) Pub. No.: US 2007/0098303 A1
(43) Pub. Date: May 3, 2007

(54) Determining a particular person from a collection

(75) Inventors: Andrew C. Gallagher, Brockport, NY (US); Madirakshi Das, Rochester, NY (US); Alexander C. Loui, Penfield, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/263,156

(22) Filed: Oct. 31, 2005

(51) Int. Cl. G06K 9/54; G06K 9/46; G06K 9/00

(52) U.S. Cl. 382/305; 382/190; 382/118; 348/231.2

(57) ABSTRACT

A method of identifying a particular person in a digital image collection, wherein at least one of the images in the digital image collection contains more than one person, includes providing at least one first label for a first image in the digital image collection containing a particular person and at least one other person; wherein the first label identifies the particular person and a second label for a second image in the digital image collection that identifies the particular person; using the first and second labels to identify the particular person; determining features related to the particular person from the first image or second image or both; and using such particular features to identify another image in the digital image collection believed to contain the particular person.

### FIELD OF THE INVENTION

The invention relates generally to the field of image processing. More specifically, the invention relates to estimating and correcting for unintentional rotational camera angles that occur at the time of image capture, based upon the captured image's corresponding location of its vanishing points. Furthermore, the invention relates to performing such image processing in a digital camera.

The present invention relates to determining if objects or persons of interest are in particular images of a collection of digital images.

### BACKGROUND OF THE INVENTION

With the advent of digital photography, consumers are amassing large collections of digital images and videos. The average number of images captures with digital cameras per photographer is still increasing each year. As a consequence, the organization and retrieval of images and videos is already a problem for the typical consumer. Currently, the length of time spanned by a typical consumer's digital image collection is only a few years. The organization and retrieval problem will continue to grow as the length of time spanned by the average digital image and video collection increases.

A user desires to find images and videos containing a particular person of interest. The user can perform a manual search to find images and videos containing the person of interest. However this is a slow, laborious process. Even though some commercial software (e.g. Adobe Album) allows users to tag images with labels indicating the people in the images so that searches can later be done, the initial labeling process is still very tedious and time consuming.

Face recognition software assumes the existence of a ground-truth labeled set of images (i.e. a set of images with corresponding person identities). Most consumer image collections do not have a similar set of ground truth. In addition, the labeling of faces in images is complex because many consumer images have multiple persons. So simply labeling an image with the identities of the people in the image does not indicate which person in the image is associated with which identity.

There exists many image processing packages that attempt to recognize people for security or other purposes. Some examples are the FaceVACS face recognition software from Cognitec Systems GmbH and the Facial Recognition SDKs from Imagis Technologies Inc. and Identix Inc. These packages are primarily intended for security-type applications where the person faces the camera under uniform illumination, frontal pose and neutral expression. These methods are not suited for use in personal consumer images due to the large variations in pose, illumination, expression and face size encountered in images in this domain.

### SUMMARY OF THE INVENTION

It is an object of the present invention to readily identify objects or persons of interests in images or videos in a digital image collection. This object is achieved by a method of identifying a particular person in a digital image collection, wherein at least one of the images in the digital image collection contains more than one person, comprising:

(a) providing at least one first label for a first image in the digital image collection containing a particular person and at least one other person; wherein the first label identifies the particular person and a second label for a second image in the digital image collection that identifies the particular person;

(b) using the first and second labels to identify the particular person;

(c) determining features related to the particular person from the first image or second image or both; and

(d) using such particular features to identify another image in the digital image collection believed to contain the particular person.

This method has the advantage of allowing users to find persons of interest with an easy to use interface. Further, the method has the advantage that images are automatically labeled with labels related to the person of interest, and allowing the user to review the labels.

### BRIEF DESCRIPTION OF THE DRAWINGS

The subject matter of the invention is described with reference to the embodiments shown in the drawings.

FIG. 1 is a block diagram of a camera phone based imaging system that can implement the present invention;

FIG. 2 is a flow chart of an embodiment of the present invention for finding a person of interest in a digital image collection;

FIG. 3 is a flow chart of an embodiment of the present invention for finding a person of interest in a digital image collection;

FIG. 4 shows a representative set of images used to initiate a search for a person of interest;

FIG. 5 shows a representative subset of images displayed to the user as a result of searching for a person of interest;

FIG. 6 shows the subset of images displayed to the user after the user has removed images not containing the person of interest;

FIG. 7 is a flow chart of an alternative embodiment of the present invention for finding a person of interest in a digital image collection;

FIG. 8 shows images and associated labels;

FIG. 9 shows a representative subset of images displayed to the user as a result of searching for a person of interest;

FIG. 10 shows the subset of images and labels displayed to the user after the user has removed images not containing the person of interest;

FIG. 11 shows a more detailed view of the feature extractor from FIG. 2;

FIG. 12A shows a more detailed view of the person detector from FIG. 2;

FIG. 12B is a plot of the relationship of the difference in image capture times and the probability that a person who appeared in one image will also appear in the second image;

FIG. 12C is a plot of the relationship of face size ratio as a function of difference in image capture times;

FIG. 12D is a representation of feature points extracted from a face by the feature extractor of FIG. 2;

FIG. 12E is a representation of face regions, clothing regions, and background regions;

FIG. 12F is a representation of various facial feature regions;

FIG. 13 shows a more detailed view of the person finder of FIG. 2.

FIG. 14 shows a plot of local features for 15 faces, the actual identities of the faces, and the possible identities of the faces; and

FIG. 15 is a flow chart of an embodiment of the present invention for finding an object of interest in a digital image collection.

### DETAILED DESCRIPTION OF THE INVENTION

In the following description, some embodiments of the present invention will be described as software programs. Those skilled in the art will readily recognize that the equivalent of such a method may also be constructed as hardware or software within the scope of the invention.

Because image manipulation algorithms and systems are well known, the present description will be directed in particular to algorithms and systems forming part of, or cooperating more directly with, the method in accordance with the present invention. Other aspects of such algorithms and systems, and hardware or software for producing and otherwise processing the image signals involved therewith, not specifically shown or described herein can be selected from such systems, algorithms, components, and elements known in the art. Given the description as set forth in the following specification, all software implementation thereof is conventional and within the ordinary skill in such arts.

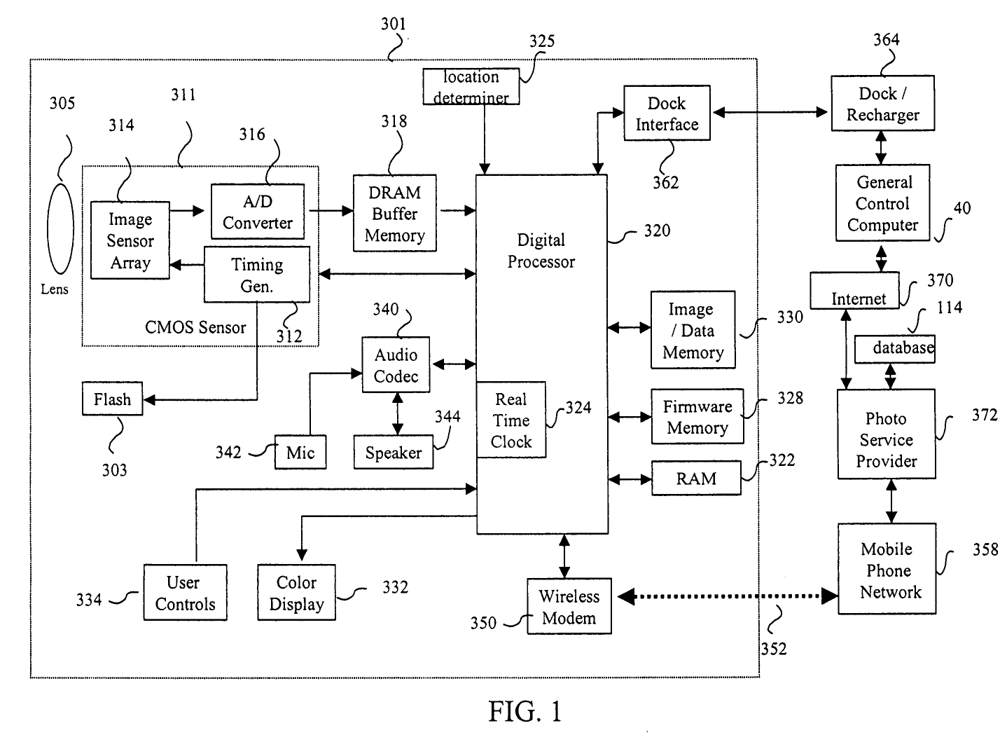

FIG. 1 is a block diagram of a digital camera phone 301 based imaging system that can implement the present invention. The digital camera phone 301 is one type of digital camera. Preferably, the digital camera phone 301 is a portable battery operated device, small enough to be easily handheld by a user when capturing and reviewing images. The digital camera phone 301 produces digital images that are stored using the image data/memory 330, which can be, for example, internal Flash EPROM memory, or a removable memory card. Other types of digital image storage media, such as magnetic hard drives, magnetic tape, or optical disks, can alternatively be used to provide the image/data memory 330.

The digital camera phone 301 includes a lens 305 that focuses light from a scene (not shown) onto an image sensor array 314 of a CMOS image sensor 311. The image sensor array 314 can provide color image information using the well-known Bayer color filter pattern. The image sensor array 314 is controlled by timing generator 312, which also controls a flash 303 in order to illuminate the scene when the ambient illumination is low. The image sensor array 314 can have, for example, 1280 columns×960 rows of pixels.

In some embodiments, the digital camera phone 301 can also store video clips, by summing multiple pixels of the image sensor array 314 together (e.g. summing pixels of the same color within each 4 column×4 row area of the image sensor array 314) to create a lower resolution video image frame. The video image frames are read from the image sensor array 314 at regular intervals, for example using a 24 frame per second readout rate.

The analog output signals from the image sensor array 314 are amplified and converted to digital data by the analog-to-digital (A/D) converter circuit 316 on the CMOS image sensor 311. The digital data is stored in a DRAM buffer memory 318 and subsequently processed by a digital processor 320 controlled by the firmware stored in firmware memory 328, which can be flash EPROM memory. The digital processor 320 includes a real-time clock 324, which keeps the date and time even when the digital camera phone 301 and digital processor 320 are in their low power state.

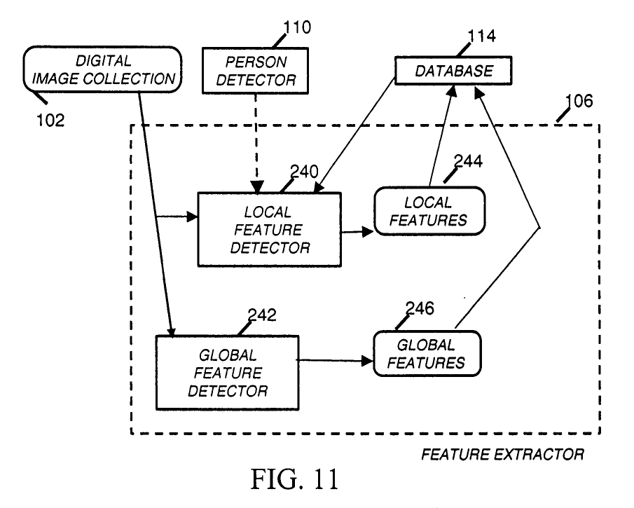

The processed digital image files are stored in the image/data memory 330. The image/data memory 330 can also be used to store the user's personal calendar information, as will be described later in reference to FIG. 11. The image/data memory can also store other types of data, such as phone numbers, to-do lists, and the like.

In the still image mode, the digital processor 320 performs color interpolation followed by color and tone correction, in order to produce rendered sRGB image data. The digital processor 320 can also provide various image sizes selected by the user. The rendered sRGB image data is then JPEG compressed and stored as a JPEG image file in the image/data memory 330. The JPEG file uses the so-called “Exif” image format described earlier. This format includes an Exif application segment that stores particular image metadata using various TIFF tags. Separate TIFF tags can be used, for example, to store the date and time the picture was captured, the lens f/number and other camera settings, and to store image captions. In particular, the ImageDescription tag can be used to store labels. The real-time clock 324 provides a capture date/time value, which is stored as date/time metadata in each Exif image file.

A location determiner 325 provides the geographic location associated with an image capture. The location is preferably stored in units of latitude and longitude. Note that the location determiner 325 may determine the geographic location at a time slightly different than the image capture time. In that case, the location determiner 325 can use a geographic location from the nearest time as the geographic location associated with the image. Alternatively, the location determiner 325 can interpolate between multiple geographic positions at times before and/or after the image capture time to determine the geographic location associated with the image capture. Interpolation can be necessitated because it is not always possible for the location determiner 325 to determine a geographic location. For example, the GPS receivers often fail to detect signal when indoors. In that case, the last successful geographic location (i.e. prior to entering the building) can be used by the location determiner 325 to estimate the geographic location associated with a particular image capture. The location determiner 325 may use any of a number of methods for determining the location of the image. For example, the geographic location may be determined by receiving communications from the well-known Global Positioning Satellites (GPS).

The digital processor 320 also creates a low-resolution “thumbnail” size image, which can be created as described in commonly-assigned U.S. Pat. No. 5,164,831 to Kuchta, et al., the disclosure of which is herein incorporated by reference. The thumbnail image can be stored in RAM memory 322 and supplied to a color display 332, which can be, for example, an active matrix LCD or organic light emitting diode (OLED). After images are captured, they can be quickly reviewed on the color LCD image display 332 by using the thumbnail image data.

The graphical user interface displayed on the color display 332 is controlled by user controls 334. The user controls 334 can include dedicated push buttons (e.g. a telephone keypad) to dial a phone number, a control to set the mode (e.g. “phone” mode, “camera” mode), a joystick controller that includes 4-way control (up, down, left, right) and a push-button center “OK” switch, or the like.

An audio codec 340 connected to the digital processor 320 receives an audio signal from a microphone 342 and provides an audio signal to a speaker 344. These components can be used both for telephone conversations and to record and playback an audio track, along with a video sequence or still image. The speaker 344 can also be used to inform the user of an incoming phone call. This can be done using a standard ring tone stored in firmware memory 328, or by using a custom ring-tone downloaded from a mobile phone network 358 and stored in the image/data memory 330. In addition, a vibration device (not shown) can be used to provide a silent (e.g. non audible) notification of an incoming phone call.

A dock interface 362 can be used to connect the digital camera phone 301 to a dock/charger 364, which is connected to a general control computer 40. The dock interface 362 may conform to, for example, the well-know USB interface specification. Alternatively, the interface between the digital camera 301 and the general control computer 40 can be a wireless interface, such as the well-known Bluetooth wireless interface or the well-know 802.11b wireless interface. The dock interface 362 can be used to download images from the image/data memory 330 to the general control computer 40. The dock interface 362 can also be used to transfer calendar information from the general control computer 40 to the image/data memory in the digital camera phone 301. The dock/charger 364 can also be used to recharge the batteries (not shown) in the digital camera phone 301.

The digital processor 320 is coupled to a wireless modem 350, which enables the digital camera phone 301 to transmit and receive information via an RF channel 352. A wireless modem 350 communicates over a radio frequency (e.g. wireless) link with the mobile phone network 358, such as a 3GSM network. The mobile phone network 358 communicates with a photo service provider 372, which can store digital images uploaded from the digital camera phone 301. These images can be accessed via the Internet 370 by other devices, including the general control computer 40. The mobile phone network 358 also connects to a standard telephone network (not shown) in order to provide normal telephone service.

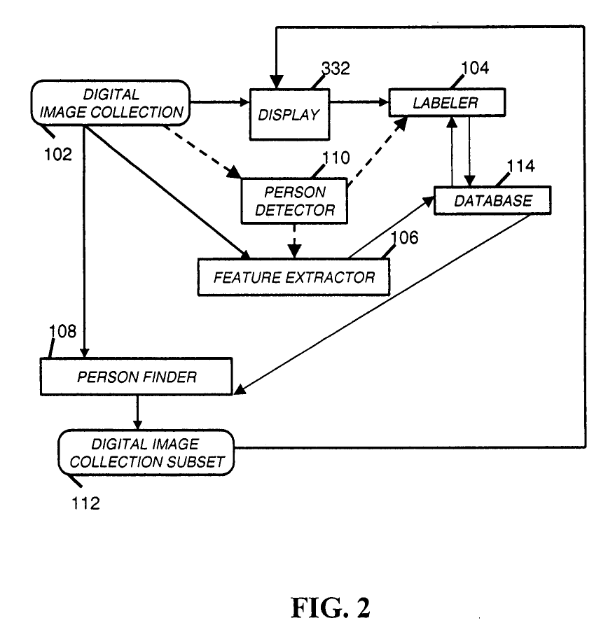

An embodiment of the invention is illustrated in FIG. 2. A digital image collection 102 containing people is searched for a person of interest by a person finder 108. A digital image collection subset 112 is the set of images from the digital image collection 102 believed to contain the person of interest. The digital image collection 102 includes both images and videos. For convenience, the term “image” refers to both single images and videos. Videos are a collection of images with accompanying audio and sometimes text. The digital image collection subset 112 is displayed on the display 332 for review by the human user.

The search for a person of interest is initiated by a user as follows: Images or videos of the digital image collection 102 are displayed on the display 332 and viewed by the user. The user establishes one or more labels for one or more of the images with a labeler 104. A feature extractor 106 extracts features from the digital image collection in association with the label(s) from the labeler 104. The features are stored in association with labels in a database 114. A person detector 110 can optionally be used to assist in the labeling and feature extraction. When the digital image collection subset 112 is displayed on the display 332, the user can review the results and further label the displayed images.

A label from the labeler 104 indicates that a particular image or video contains a person of interest and includes at least one of the following:

(1) the name of a person of interest in an image or video. A person's name can be a given name or a nickname.

(2) an identifier associated with the person of interest such as a text string or identifier such as “Person A” or “Person B”.

(3) the location of the person of interest within the image or video. Preferably, the location of the person of interest is specified by the coordinates (e.g. the pixel address of row and column) of the eyes of the person of interest (and the associated frame number in the case of video). Alternatively, the location of the person of interest can be specified by coordinates of a box that surrounds the body or the face of the person of interest. As a further alternative, the location of the person of interest can be specified by coordinates indicating a position contained within the person of interest. The user can indicate the location of the person of interest by using a mouse to click on the positions of the eyes for example. When the person detector 110 detects a person, the position of the person can be highlighted to the user by, for example, circling the face on the display 332. Then the user can provide the name or identifier for the highlighted person, thereby associating the position of the person with the user provided label. When more than one person is detected in an image, the positions of the persons can be highlighted in turn and labels can be provided by the user for any of the people.

(4) an indication to search for images or videos from the image collection believed to contain the person of interest.

(5) the name or identifier of a person of interest who is not in the image.

The digital image collection 102 contains at least one image having more than one person. A label is provided by the user via the labeler 104, indicating that the image contains a person of interest. Features related to the person of interest are determined by the feature extractor 106, and these features are used by the person finder 108 to identify other images in the collection that are believed to contain the person of interest.

Note that the terms “tag”, “caption”, and “annotation” are used synonymously with the term “label.”

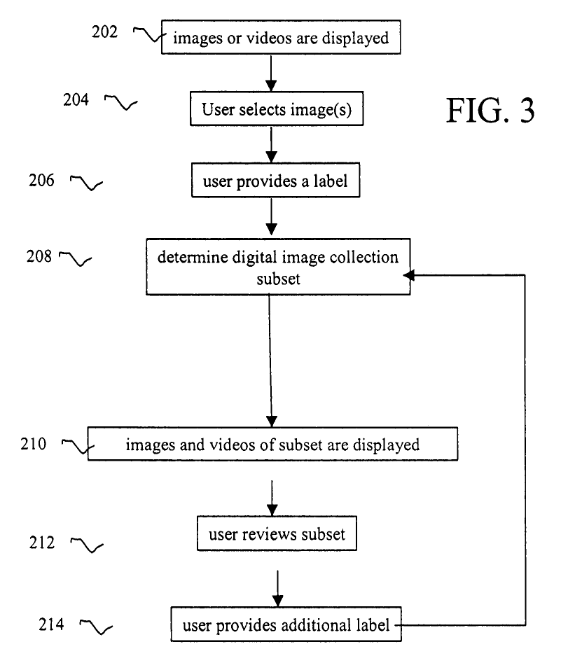

FIG. 3 is a flow diagram showing a method for using a digital camera to identify images believed to contain a person of interest. Those skilled in the art will recognize that the processing platform for using the present invention can be a camera, a personal computer, a remote computer assessed over a network such as the Internet, a printer, or the like. In this embodiment, a user selects a few images or videos containing a person of interest, and the system determines and displays images or videos from a subset of the digital image collection believed to contain the person of interest. The displayed images can be reviewed by the user, and the user can indicate whether the displayed images do contain the person of interest. In addition , the user can verify or provide the name of the person of interest. Finally, based on the input from the user, the system can again determine a set of images believed to contain the person of interest.

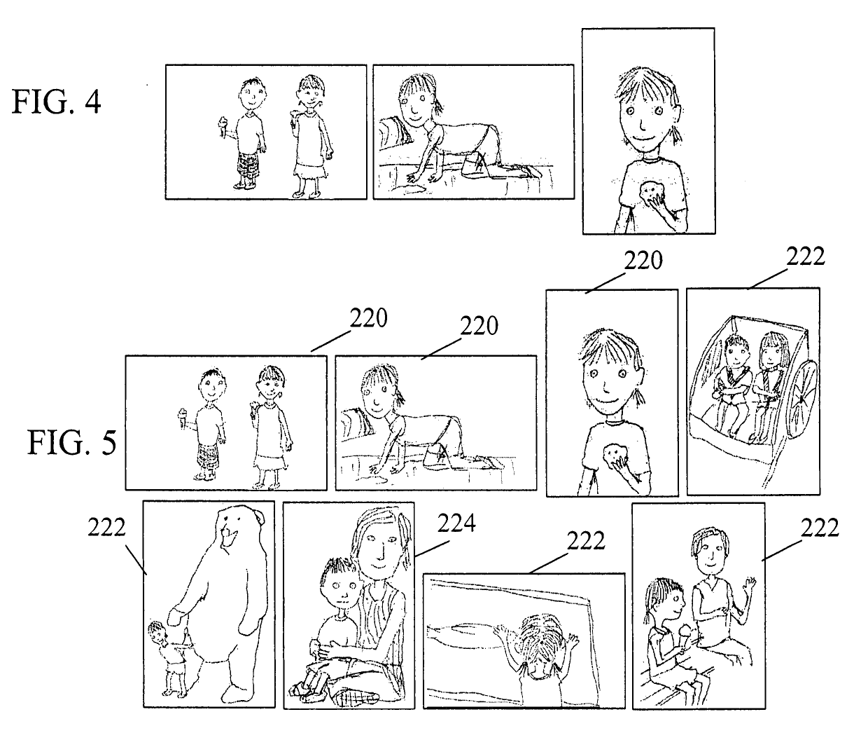

In block 202, images are displayed on the display 332. In block 204, the user selects images, where each image contains the person of interest. At least one of the selected images contains a person besides the person of interest. For example, FIG. 4 shows a set of three selected images, each containing the person of interest, and one of the images contains two people. In block 206, the user provides a label via the labeler 104 that indicates the selected images contain the person of interest and the images and videos from the image collection are to be searched by the person finder 108 to identify those believed to contain the person of interest. In block 208, the person identifier accesses the features and associated labels stored in the database 114 and determines a digital image collection subset 112 of images and videos believed to contain the person of interest. In block 210, the digital image collection subset 112 is displayed on the display 332. For example, FIG. 5 shows images in the digital image collection subset 112. The digital image collection subset contains labeled images 220, images correctly believed to contain the person of interest 222, and images incorrectly believed to contain the person of interest 224. This is a consequence of the imperfect nature of current face detection and recognition technology. In block 212, the user reviews the digital image collection subset 112 and can indicate the correctness of each image in the digital image collection subset 112. This user indication of correctness is used to provide additional labels via the labeler 104 in block 214. For example, the user indicates via the user interface that all of the images and videos correctly believes to contain the person of interest 222 of the digital image collection subset 112 do contain the person of interest. Each image and video of the digital image collection is then labeled with the name of the person of interest if it has been provided by the user. If the name of the person of interest has not been provided by the user, the name of the person of interest can be determined in some cases by the labeler 104. The images and videos of the digital image collection subset 112 are examined for those having a label indicating the name of the person of interest and for which the person detector 110 determines contain only one person. Because the user has verified that the images and videos of the digital image collection subset 112 do contain the person of interest and the person detector 110 finds only a single person, the labeler 104 concludes that the name of the person in the associated label is the name of the person of interest. If the person detector 110 is an automatic error-prone algorithm, then the labeler 104 may need to implement a voting scheme if more than one image and videos have an associated label containing a person's name and the person detector 110 finds only one person, and the person's name in the associated label is not unanimous. For example, if there are 3 images among the digital image collection subset 112 that contain one detected person each by the person detector 110, and each image has a label containing a person's name, and the names are: “Hannah”, “Hannah”, and “Holly”, then the voting scheme conducted by the labeled 104 determines that the person's name is “Hannah”. The labeler 104 then labels the images and videos of the digital image collection subset 112 with a label containing the name of the person of interest (e.g. “Hannah”). The user can review the name of the person of interest determined by the labeler 104 via the display. After the user indicates that the images and videos of the digital image collection subset 112 contain the person of interest, the message “Label as Hannah?” appears, and the user can confirm the determined name of the person of interest by pressing “yes”, or enter a different name for the person of interest by pressing “no”. If the labeler 104 cannot determine the name of the person of interest, then a currently unused identifier is assigned to the person of interest (e.g. “Person 12”), and the images and videos of the digital image collection subset 112 are labeled by the labeler 104 accordingly.

Alternatively, the labeler 104 can determine several candidate labels for the person of interest. The candidate labels can be displayed to the user in the form of a list. The list of candidate labels can be a list of labels that have been used in the past, or a list of the most likely labels for the current particular person of interest. The user can then select from the list the desired label for the person of interest.

Alternatively, if the labeler 104 cannot determine the name of the person of interest, the user can be asked to enter the name of the person of interest by displaying the message “Who is this?” on the display 332 and allowing the user to enter the name of the person of interest, which can then be used by the labeler 104 to label the images and videos of the digital image collection subset 112.

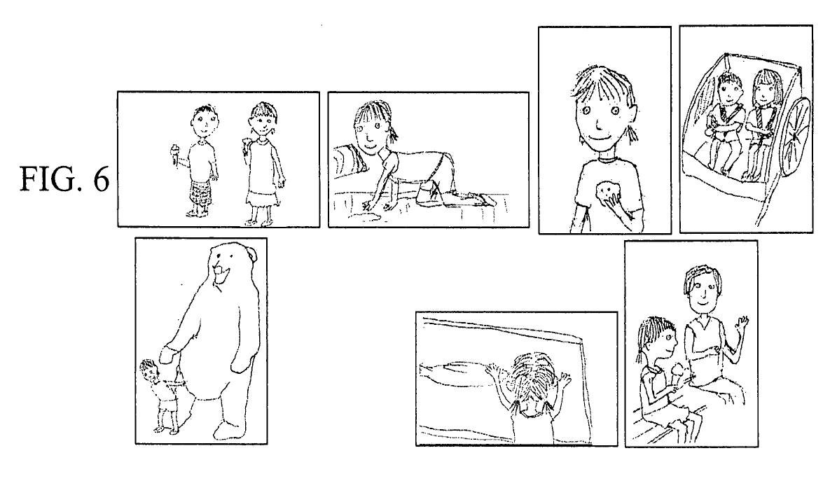

The user can also indicate, via the user interface, those images of the images and videos of the digital image collection subset 112 do not contain the person of interest. The indicated images are then removed from the digital image collection subset 112, and the remaining images can be labeled as previously described. The indicated images can be labeled to indicate that they do not contain the person of interest so that in future searches for that same person of interest, an image explicitly labeled as not containing the person of interest will not be shown to the user. For example, FIG. 6 shows the digital image collection subset 112 after an image incorrectly believed to contain the person of interest is removed.

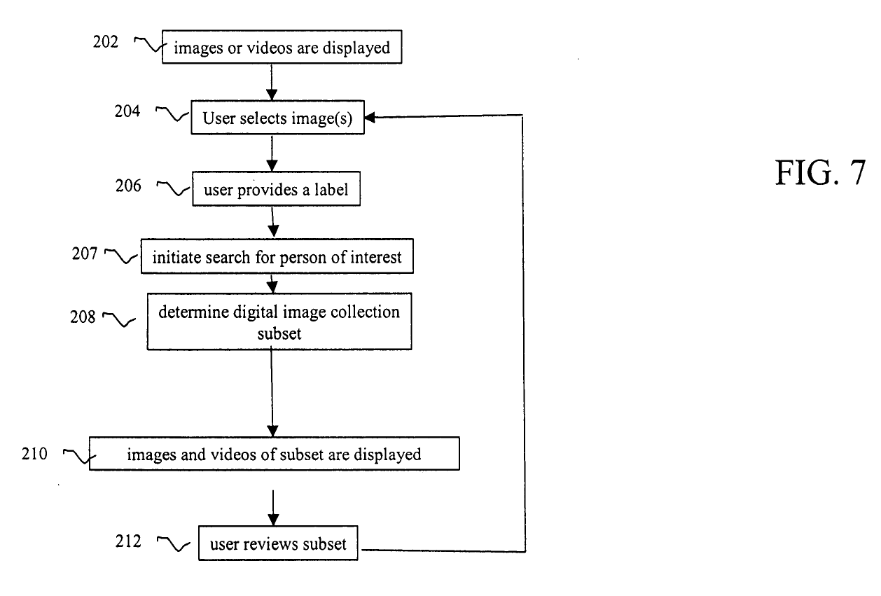

FIG. 7 is a flow diagram showing an alternative method for identifying images believed to contain a person of interest. In this embodiment, a user labels the people in one or more images or videos, initiates a search for a person of interest, and the system determines and displays images or videos from a subset of the digital image collection 102 believed to contain the person of interest. The displayed images can be reviewed by the user, and the user can indicate whether the displayed images do contain the person of interest. In addition, the user can verify or provide the name of the person of interest. Finally, based on the input from the user, the system can again determine a set of images believed to contain the person of interest.

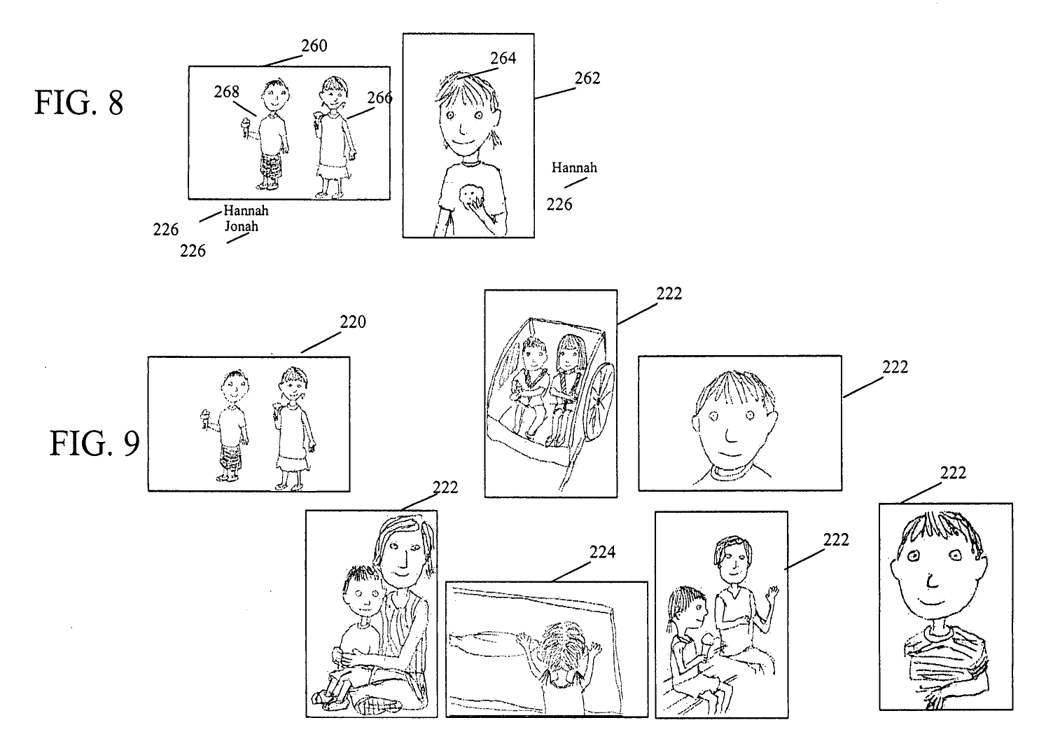

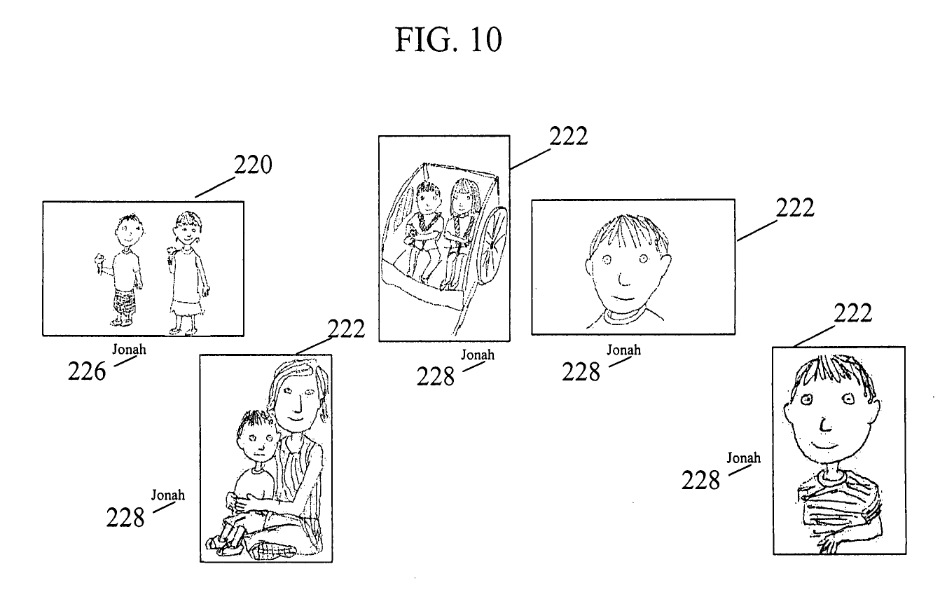

In block 202, images are displayed on the display 332. In block 204, the user selects images, where each image contains the person of interest. At least one of the selected images contains more than one person. In block 206, the user provides labels via the labeler 104 to identify the people in the selected images. Preferably, the label does not indicate the location of persons within the image or video. Preferably, the label indicates the name of the person or people in the selected images or videos. FIG. 8 shows two selected images and the associated labels 226 indicating the names of people in each of the two selected images. In block 207, the user initiates a search for a person of interest. The person of interest is the name of a person that has been used as a label when labeling people in selected images. For example, the user initiates a search for images of “Jonah.” In block 208, the person identifier accesses the features from the features extractor 106 and associated labels stored in the database 114 and determines the digital image collection subset 112 of images and videos believed to contain the person of interest. In block 210, the digital image collection subset 112 is displayed on the display 332. FIG. 9 shows that the digital image collection subset 112 contains labeled images 220, images correctly believed to contain the person of interest 222, and images incorrectly believed to contain the person of interest 224. This is a consequence of the imperfect nature of current face detection and recognition technology. In block 212, the user reviews the digital image collection subset 112 and can indicate the correctness of each image in the digital image collection subset 112. This user indication of correctness is used to provide additional labels via the labeler 104 in block 204. For example, the user indicates via the user interface that all of the images and videos correctly believes to contain the person of interest 222 of the digital image collection subset 112 do contain the person of interest. The user can also indicate, via the user interface, those images of the images and videos of the digital image collection subset 112 do not contain the person of interest. The indicated images are then removed from the digital image collection subset 112, and the remaining images can be labeled as previously described. Each image and video of the digital image collection subset 112 is then labeled with the name of the person of interest. The user can review the name of the person of interest determined by the labeler 104 via the display. After the user indicates that the images and videos of the digital image collection subset 112 contain the person of interest, the message “Label as Jonah?” appears, and the user can confirm the determined name of the person of interest by pressing “yes”, or enter a different name for the person of interest by pressing “no.” FIG. 10 shows the digital image collection subset 112 after the user has removed images incorrectly believed to contain the person of interest, and an automatically generated label 228 used to label the images that have been reviewed by the user.

Note that the person of interest and images or videos can be selected by any user interface known in the art. For example, if the display 332 is a touch sensitive display, then the approximate location of the person of interest can be found by determining the location that the user touches the display 332.

FIG. 11 describes the feature extractor 106 from FIG. 2 in greater detail. The feature extractor 106 determines features related to people from images and videos in the digital image collection. These features are then user by the person finder 108 to find images or videos in the digital image collection believed to contain the person of interest. The feature extractor 106 determines two types of features related to people. The global feature detector 242 determines global features 246. A global feature 246 is a feature that is independent of the identity or position of the individual in an image of video. For example, the identity of the photographer is a global feature because the photographer's identity is constant no matter how many people are in an image or video and is likewise independent of the position and identities of the people.

Additional global features 246 include:

Image/video file name.

Image/video capture time. Image capture time can be a precise minute in time, e.g. Mar. 27, 2004 at 10:17 AM. Or the image capture time can be less precise, e.g. 2004 or March 2004. The image capture time can be in the form of a probability distribution function e.g. Mar. 27, 2004 +/−2 days with 95% confidence. Often times the capture time is embedded in the file header of the digital image or video. For example, the EXIF image format (described at www.exif.org) allows the image or video capture device to store information associated with the image or video in the file header. The “Date\Time” entry is associated with the date and time the image was captured. In some cases, the digital image or video results from scanning film and the image capture time is determined by detection of the date printed into the image (as is often done at capture time) area, usually in the lower left comer of the image. The date a photograph is printed is often printed on the back of the print. Alternatively, some film systems contain a magnetic layer in the film for storing information such as the capture date.

Capture condition metadata (e.g. flash fire information, shutter speed, aperture, ISO, scene brightness, etc.) Geographic location. The location is preferably stored in units of latitude and longitude.

Scene environment information. Scene environment information is information derived from the pixel values of an image or video in regions not containing a person. For example, the mean value of the non-people regions in an image or video is an example of scene environment information. Another example of scene environment information is texture samples (e.g. a sampling of pixel values from a region of wallpaper in an image).

Geographic location and scene environment information are important clues to the identity of persons in the associated images. For example, a photographer's visit to grandmother's house could be the only location where grandmother is photographed. When two images are captured with similar geographic locations and environments, it is more likely that detected persons in the two images are the same as well.

Scene environment information can be used by the person detector 110 to register two images. This is useful when the people being photographed are mostly stationary, but the camera moves slightly between consecutive photographs. The scene environment information is used to register the two images, thereby aligning the positions of the people in the two frames. This alignment is used by the person finder 108 because when two persons have the same position in two images captured closely in time and registered, then the likelihood that the two people are the same individual is high.

The local feature detector 240 computes local features 244. Local features are features directly relating to the appearance of a person in an image or video. Computation of these features for a person in an image or video requires knowledge of the position of the person. The local feature detector 240 is passed information related to the position of a person in an image of video from either the person detector 110, or the database 114, or both. The person detector 110 can be a manual operation where a user inputs the position of people in images and videos by outlining the people, indicating eye position, or the like. Preferable, the person detector 110 implements a face detection algorithm. Methods for detecting human faces are well known in the art of digital image processing. For example, a face detection method for finding human faces in images is described in the following article: Jones, M. J.; Viola, P., “Fast Multi-view Face Detection”, IEEE Conference on Computer Vision and Pattern Recognition (CVPR), June 2003.

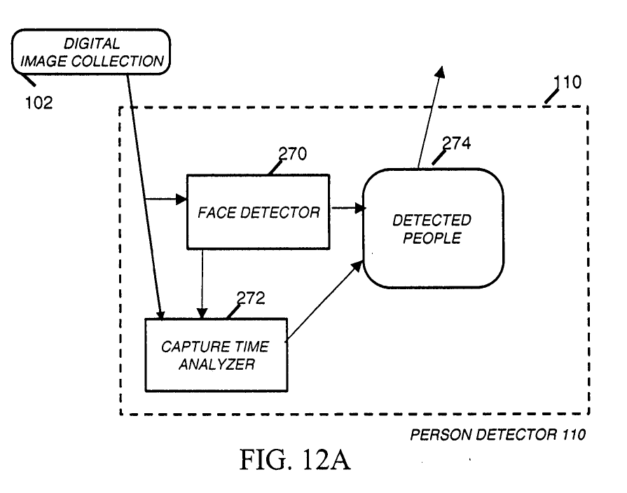

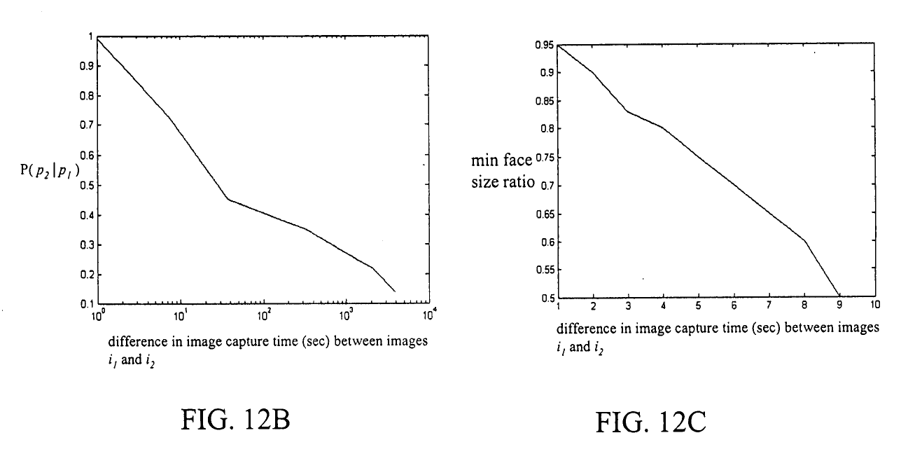

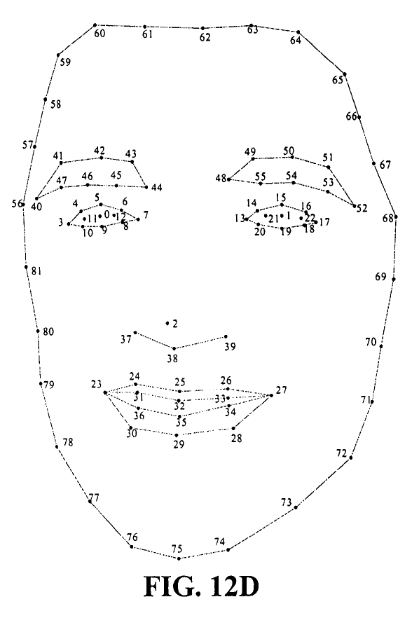

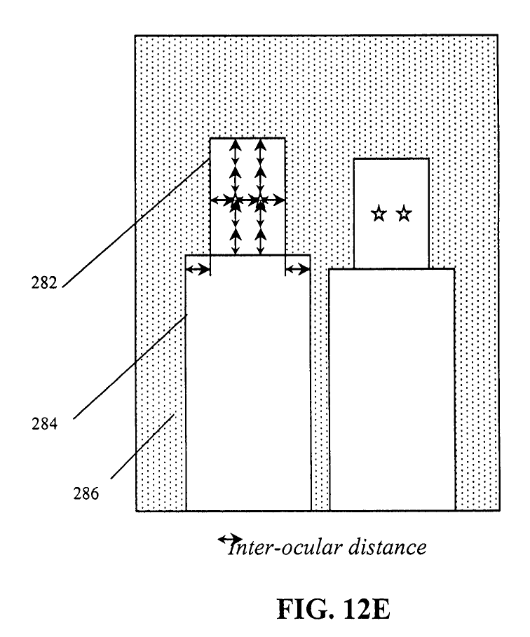

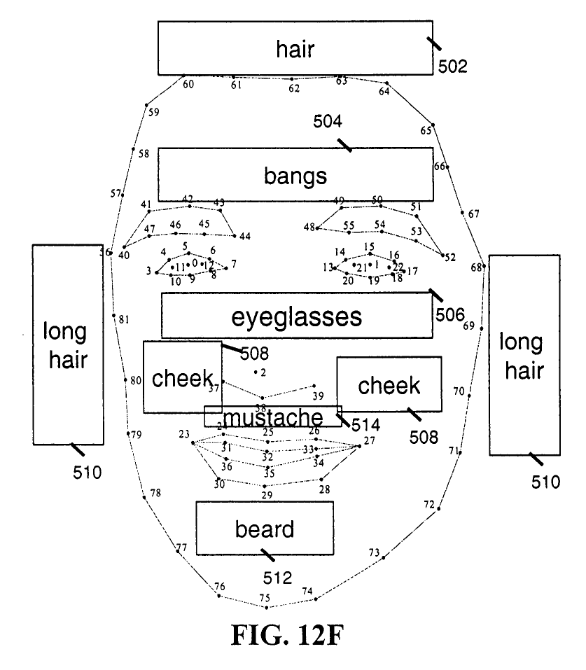

An effective, person detector 110 is based on the image capture time associated with digital images and videos is described with regard to FIG. 12A. The images and videos of the digital image collection 102 are analyzed by a face detector 270, such as the aforementioned face detector by Jones and Viola. The face detector is tuned to provide detected people 274 while minimizing false detections. As a consequence, many people in images are not detected. This can be a consequence of, for example, having their back to the camera, or a hand over the face. The detected faces from the face detector 270 and the digital image collection 102 are passed to a capture time analyzer 272 to find images containing people that were missed by the face detector 270. The capture time analyzer 272 operates on the idea that, when two images are captured very close in time, it is likely that if an individual appears in one image, then he or she also appears in the other image as well. In fact, this relationship can be determined with fairly good accuracy by analyzing large collections of images when the identities of persons in the images are known. For processing videos, face tracking technology is used to find the position of a person across frames of the video. One method of face tracking is video is described in U.S. Pat. No. 6,700,999, where motion analysis is used to track faces in video.

FIG. 12B shows a plot of the relationship used by the capture time analyzer 272. The plot shows the probability of a person appearing in a second image, given that the person appeared in a first image, as a function of the difference in image capture time between the images. As expected, when two images are captured in rapid succession, the likelihood that a person appears in one image and not the other is very low.

The capture time analyzer 272 examines images and videos in the digital image collection 110. When a face is detected by the face detector 270 in a given image, then the probability that that same person appears in another image is calculated using the relationship shown in FIG. 12B.

For example, assume that the face detector 270 detected two faces in one image, and a second image, captured only 1 second later, the face detector 270 found only one face. Assuming that the detected faces from the first image are true positives, the probability is quite high (0.99* 0.99) that the second image also contains two faces, but only one found by the face detector 270. Then, the detected people 274 for the second image are the one face found by the face detector 270, and second face with confidence 0.98. The position of the second face is not known, but can be estimated because, when the capture time difference is small, neither the camera nor the people being photographed tend to move quickly. Therefore, the position of the second face in the second image is estimated by the capture time analyzer 272. For example, when an individual appears in two images, the relative face size (the ration of the size of the smaller face to the larger face) can be examined. When the capture times of two images containing the same person is small, the relative face size usually falls near 1, because the photographer, and the person being photographed and the camera settings are nearly constant. A lower limit of the relative face size is plotted as a function of difference in image capture times in FIG. 12C. This scaling factor can be used in conjunction with the known face position of a face in a first image to estimate a region wherein the face appears in the second image.

Note that the method used by the capture time analyzer 272 can also be used to determine the likelihood that a person of interest in is a particular image or video by the person finder 108.

Also, the database 114 stores information associated with labels from the labeler 104 of FIG. 2. When the label contains position information associated with the person, the local feature detector 240 can determine local features 244 associated with the person.

Once the position of a person is known, the local feature detector 240 can detect local features 244 associated with the person. Once a face position is known, the facial features (e.g. eyes, nose, mouth, etc.) can also be localized using well known methods such as described by Yuille et al. in, “Feature Extraction from Faces Using Deformable Templates,” Int. Journal of Comp. Vis., Vol. 8, Iss. 2, 1992, pp. 99-111. The authors describe a method of using energy minimization with template matching for locating the mouth, eye and iris/sclera boundary. Facial features can also be found using active appearance models as described by T. F. Cootes and C. J. Taylor “Constrained active appearance models”, 8th International Conference on Computer Vision, volume 1, pages 748-754. IEEE Computer Society Press, July 2001. In the preferred embodiment, the method of locating facial feature points based on an active shape model of human faces described in “An automatic facial feature finding system for portrait images”, by Bolin and Chen in the Proceedings of IS&T PICS conference, 2002 is used.

The local features 244 are quantitative descriptions of a person. Preferably, the person finder feature extractor 106 outputs one set of local features 244 and one set of global features 246 for each detected person. Preferably the local features 244 are based on the locations of 82 feature points associated with specific facial features, found using a method similar to the aforementioned active appearance model of Cootes et al. A visual representation of the local feature points for an image of a face is shown in FIG. 12D as an illustration. The local features can also be distances between specific feature points or angles formed by lines connecting sets of specific feature points, or coefficients of projecting the feature points onto principal components that describe the variability in facial appearance.

The features used are listed in Table 1 and their computations refer to the points on the face shown numbered in FIG. 12D. Arc (Pn, Pm) is defined as

$${\sum }_{i = n}^{m - 1} ‖ Pn - P ( n + 1 ) ‖$$

where ∥Pn-Pm∥ refers to the Euclidean distance between feature points n and m. These arc-length features are divided by the inter-ocular distance to normalize across different face sizes. Point PC is the point located at the centroid of points 0 and 1 (i.e. the point exactly between the eyes). The facial measurements used here are derived from anthropometric measurements of human faces that have been shown to be relevant for judging gender, age, attractiveness and ethnicity (ref. “Anthropometry of the Head and Face” by Farkas (Ed.), 2^{nd} edition, Raven Press, New York, 1994).

TABLE 1
List of Ration Features

| Name | Numerator | Denominator |
|---|---|---|
| Eye-to-nose/Eye-to-mouth | PC-P2 | PC-P32 |
| Eye-to-mouth/Eye-to-chin | PC-P32 | PC-P75 |
| Head-to-chin/Eye-to-mouth | P62-P75 | PC-P32 |
| Head-to-eye/Eye-to-chin | P62-PC | PC-P75 |
| Head-to-eye/Eye-to-mouth | P62-PC | PC-P32 |
| Nose-to-chin/Eye-to-chin | P38-P75 | PC-P75 |
| Mouth-to-chin/Eye-to-chin | P35-P75 | PC-P75 |
| Head-to-nose/Nose-to-chin | P62-P2 | P2-P75 |
| Mouth-to-chin/Nose-to-chin | P35-P75 | P2-P75 |
| Jaw width/Face width | P78-P72 | P56-P68 |
| Eye-spacing/Nose width | P07-P13 | P37-P39 |
| Mouth-to-chin/Jaw width | P35-P75 | P78-P72 |

TABLE 2
List of Arc Length Features

| Name | Computation |
|---|---|
| Mandibular arc | Arc (P69, P81) |
| Supra-orbital arc | (P56-P40) + Int (P40, P44) + (P44-P48) + |
| | Arc (P48, P52) + (P52-P68) |
| Upper-lip arc | Arc (P23, P27) |
| Lower-lip arc | Arc (P27, P30) + (P30-P23) |

Color cues are easily extracted from the digital image or video once the person and facial features are located by the person finder 106.

Alternatively, different local features can also be used. For example, an embodiment can be based upon the facial similarity metric described by M. Turk and A. Pentland. In “Eigenfaces for Recognition”. Journal of Cognitive Neuroscience. Vol 3, No. 1. 71-86, 1991. Facial descriptors are obtained by projecting the image of a face onto a set of principal component functions that describe the variability of facial appearance. The similarity between any two faces is measured by computing the Euclidean distance of the features obtained by projecting each face onto the same set of functions.

The local features 244 could include a combination of several disparate feature types such as Eigenfaces, facial measurements, color/texture information, wavelet features etc.

Alternatively, the local features 244 can additionally be represented with quantifiable descriptors such as eye color, skin color, face shape, presence of eyeglasses, description of clothing, description of hair, etc.

For example, Wiskott describes a method for detecting the presence of eyeglasses on a face in “Phantom Faces for Face Analysis”, Pattern Recognition, Vol. 30, No. 6, pp. 837-846, 1997. The local features contain information related to the presence and shape of glasses.

FIG. 12E shows the areas in the image hypothesized to be the face region 282, clothing region 284 and background region 286 based on the eye locations produced by the face detector. The sizes are measured in terms of the inter-ocular distance, or IOD (distance between the left and right eye location). The face covers an area of three times IOD by four times IOD as shown. The clothing area covers five times IOD and extends to the bottom of the image. The remaining area in the image is treated as the background. Note that some clothing area may be covered by other faces and clothing areas corresponding to those faces.

Images and videos in a digital image collection 102 are clustered into events and sub-events, according to U.S. Pat. No. 6,606,411 has consistent color distribution, and therefore, these pictures are likely to have been taken with the same backdrop. For each sub-event, a single color and texture representation is computed for all background areas taken together. The color and texture representations and similarity are derived from U.S. Pat. No. 6,480,840 by Zhu and Mehrotra. According to their method, color feature-based representation of an image is based on the assumption that significantly sized coherently colored regions of an image are perceptually significant. Therefore, colors of significantly sized coherently colored regions are considered to be perceptually significant colors. Therefore, for every input image, its coherent color histogram is first computed, where a coherent color histogram of an image is a function of the number of pixels of a particular color that belong to coherently colored regions. A pixel is considered to belong to a coherently colored region if its color is equal or similar to the colors of a pre-specified minimum number of neighboring pixels. Furthermore, texture feature-based representation of an image is based on the assumption that each perceptually significantly texture is composed of large numbers of repetitions of the same color transition(s). Therefore, by identifying the frequently occurring color transitions and analyzing their textural properties, perceptually significant textures can be extracted and represented.

The eye locations produced by the face detector are used to initialize the starting face position for facial feature finding. FIG. 12F shows the locations of the feature points on a face and the corresponding image patches where the named secondary features may be located.

Table 3 lists the bounding boxes for these image patches shown in FIG. 12F, the hair region 502, the bangs region 504, the eyeglasses region 506, the cheek region 508, the long hair regions 510, the beard region 512, and the mustache region 514, where Pn refers to facial point number n from FIG. 12F or FIG. 12D and [x] and [y] refer to the x and y-coordinate of the point. (Pn-Pm) is the Euclidean distance between points n and m. The “cheek” and “hair” patches are treated as reference patches (denoted by [R] in the table) depicting a feature-less region of the face and the person's hair respectively. Secondary features are computed as gray-scale histogram difference between the potential patch containing the secondary feature and the appropriate reference patch. Left and right patches are combined to generate the histograms for each secondary feature. The histograms are normalized by the number of pixels so that the relative sizes of the patches being compared are not a factor in the difference computed. Secondary features are treated as binary features—they are either present or absent. A threshold is used to ascertain whether the secondary feature is present. Table 4 gives a table showing the histogram differences used for each of the secondary features to be detected.

TABLE 3
Bounding boxes of facial feature regions.

| | Bounding box | | | |
|---|---|---|---|---|
| | x-start | y-start | width | height |
| Cheek[R] | P80[x] + ⅓ | Mean (P80[y], P81[y]) | ⅔ (P37-P80) | P79-P80 |
| (right) | (P37-P80) | | | |
| Cheek[R] | P39[x] | Mean (P69[y], P70[y]) | ⅔ (P39-P70) | P70-P69 |
| (left) | | | | |
| Hair[R] | P61[x] | P62[y] − height | P63-P61 | P68-P17 |
| Long hair | P56[x] − 2*width | P56[y] | P56-P3 | P56-P79 |
| (left) | | | | |
| Long hair | P68[x] + width | P68[y] | P68-P17 | P71-P68 |
| (right) | | | | |
| Eyeglass | P56[x] + ⅓ | Mean (P56[y], P81[y]) | ⅔ (P7-P56) | ½ (P56-P81) |
| (left) | (P7-P56) | | | |
| Eyeglass | P13[x] | Mean (P68[y], P69[y]) | ⅔ (P13-P68) | ½ (P69-P68) |
| (right) | | | | |
| Bangs | P60[x] | Mean (P60[y], P64[y]) | P64-P60 | ⅔ (P42-P60) |
| Mustache | P23[x] | P38[y] | P27-P23 | P38-P25 |
| Beard | Mean (P30[x], | Mean (P75[y], P35[y]) | Mean (P28-P30, | ½ (P75-P35) |
| | P76[x] | | P74-P76) | |

TABLE 4
histogram differences for secondary features.

| Feature | Histogram difference test |
|---|---|
| Long hair | Long hair − Hair < threshold |
| Eyeglass | Eyeglass − Cheek > threshold |
| Bangs | Bangs − Cheek > threshold |
| Mustache | Mustache − Cheek > threshold |
| Beard | Beard − Cheek > threshold |

Again referring to FIG. 11, the global features 246 and local features 244 are stored in the database 114. Global features associated with all people in an image are represented by F_{G}. The N sets of local features associated with the N people in an image are represented as F_{L0}, F_{L1}, . . . , F_{LN-1}. The complete set of features for a person n in the image is represented as Fₙ, and includes the global features F_{G} and the local features F_{Ln}. The M labels associated with the image are represented as L₀, L₁, . . . , L_{M-1}. When the label does not include the position of the person, there is ambiguity in knowing which label is associated with which set of features representing persons in the image or video. For example, when there are two sets of features describing two people in an image and two labels, it is not obvious which features belongs with which label. The person finder 108 solves this constrained classification problem of matching labels with sets of local features, where the labels and the local features are associated with a single image. There can be any number of labels and local features, and even a different number of each.

Here is an example entry of labels and features associated with an image in the database 114:
Image 101_346.JPG
Label L₀: Hannah
Label L₁: Jonah
Features F₀:
   Global Features F_{G}:
      Capture Time: Aug. 7, 2005, 6:41 PM EST.
      Flash Fire: No
      Shutter Speed: 1/724 sec.
      Camera Model: Kodak C360 Zoom Digital Camera
      Aperture: F/2.7
      Environment:
   Local Features F_{LO}:
      Position: Left Eye: [1400 198] Right Eye: [1548 202 ]
      C₀=[−0.8, −0.01]′;
      Glasses: none
   Associated Label: Unknown
Features F₁:
   Global Features F_{G}:
      Capture Time: Aug. 7, 2005, 6:41 PM EST.
      Flash Fire: No
      Shutter Speed: 1/724 sec.
      Camera Model: Kodak C360 Zoom Digital Camera
      Aperture: F/2.7
      Environment:
   Local Features: F_{L1}:
      Position: Left Eye: [810 192] Right Eye: [956 190]
      C₁=[0.06, 0.26]′;
      Glasses: none
   Associated Label: Unknown

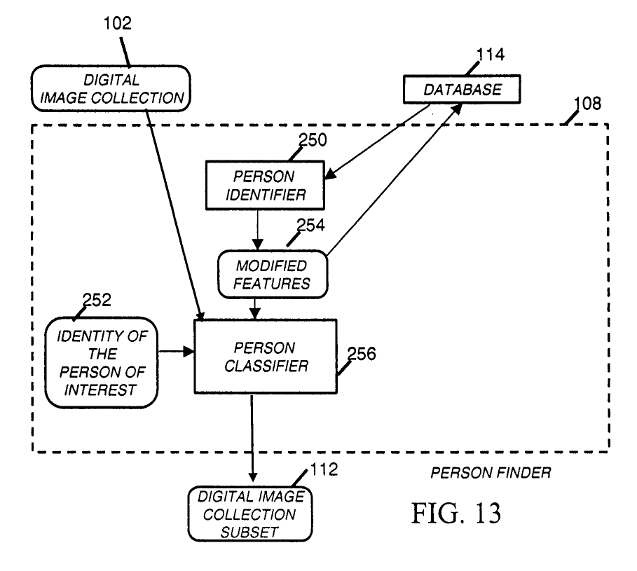

FIG. 13 describes the person finder 108 of FIG. 2 in greater detail. A person identifier 250 considers the features and labels in the database 114 and determines the identity (i.e. determines a set of related features) of people in images that were labeled with labels not containing the position of the person. The person identifier 250 associates features from the feature extractor 106 with labels from the labeler 104, thereby identifying person in an image or video. The person identifier 250 updates the features from the database and produces modified features 254 that are stored in the database 114. As an example, consider the images shown in FIG. 8. The first image 260 contains 2 people, who according to the labels 226 are Hannah and Jonah. However, it is not known which person is Hannah and which is Jonah because the labels do not contain position. The second image 262 is labeled Hannah. Because there is only one person, that person can be identified with high confidence as Hannah. The person identifier 250 can determine the identities of the people in the first image 260 by using features related to Hannah from the second image 262 and comparing the features of the people in the first image 260. A person 266 has features similar to the features to a person 264 identified as Hannah in the second image 262. The person identifier 250 can conclude, with high confidence, that person 266 in the first image 260 is Hannah, and by elimination person 268 is Jonah. The label 226 Hannah for the first image 260 is associated with the global features F_{G} for the image and the local features associated with the person 266. The label 226 Jonah for the first image 260 is associated with the global features for the image and the local features associated with the person 268. Since the identities of the people are determined, the user can initiate a search for either Hannah or Jonah using the appropriate features.

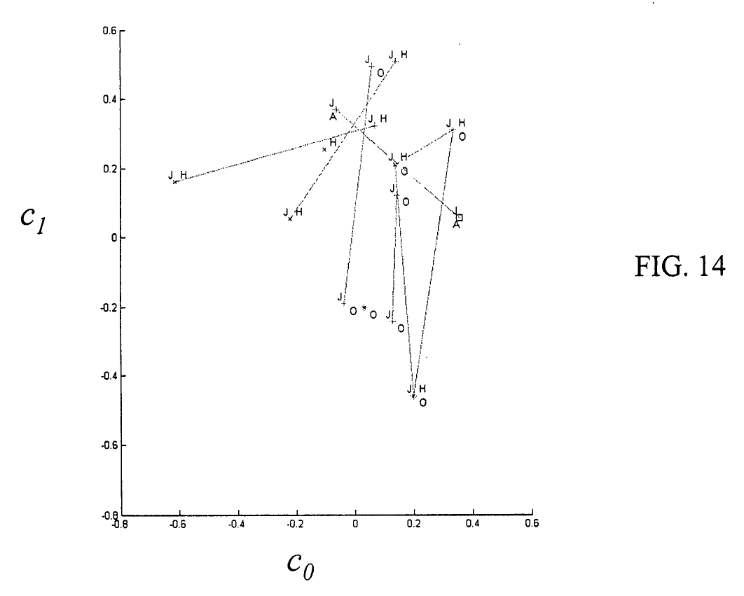

Generally speaking, the person identifier 250 solves a classification problem. The problem is to associate labels not having position information with local features, where the labels and the local features are both associated with the same image. An algorithm to solve this problem is implemented by the person identifier 250. FIG. 14 shows a representation of actual local features computed from a digital image collection. The positions of 15 sets of local features are marked on the plot. The symbol used to represent the mark indicates the true identity of a person associated with the local features “x” for Hannah, “+” for Jonah, “*” for Holly, and “□” (a box) for Andy. Each set of local features could be associated with any of the labels assigned to the image. Near each set of local features marked on the plot are the possible labels that could be associated with the local features “A” for Andy, “H” for Hannah, “J” for Jonah, and “O” for Holly. The table below shows the data. Links between marks on the plot indicate that the sets of local features are from the same image. The algorithm used to assign local features to labels works by finding an assignment of local features to labels that minimizes the collective variance (i.e. the sum of the spread of the data points assigned to each person) of the data points. The assignments of local features to labels are subject to the constraint that a label can only be used once for each image (i.e. once for each set of data points connected by links). Preferably, the collective variance is computed as the sum over each data point of the squared distance from the data point to the centroid of all data points assigned to that same individual.

The algorithm for classifying the local features can be summarized by the equation:

$${min}_{{d}_{j}} {\sum }_{j} {( {c}_{{d}_{j}} - {f}_{j} )}^{T} ( {c}_{{d}_{j}} - {f}_{j} )$$

Where:
fⱼ represents the j^{th} set of local features
dⱼ represents the class (i.e. the identity of the individual) that the j^{th} set of local features is assigned to
C_{d}_{ⱼ} represents the centroid of the class that the j^{th} set of local features is assigned to

The expression is minimized by choosing the assignments of the class for each of the j^{th} set of local features.

In this equation, a Euclidean distance measure is used. Those skilled in the art will recognize that many different distance measures, such as Mahalanobis distance, or the minimum distance between the current data point and another data point assigned to the same class, can be used as well.

This algorithm correctly associates all 15 local features in the example with the correct label. Although in this example the number of labels and the number of sets of local features in each image was the same in the case of each image, which is not necessary for the algorithm used by the person identifier 250 to be useful. For example, a user can provide only two labels for an image containing three people and from which three sets of local features are derived.

In some cases, the modified features 254 form the person identifier 250 are straightforward to generate from the database 114. For example, when the database contains only global features and no local features, then the features associated with each label (whether or not the label contains position information) will be identical. For example, if the only feature is image capture time, then each label associated with the image is associated with the image capture time. Also, if the labels contain position information, then associating features with the labels is easy because either the features do not include local features and therefore the same features are associated with each label, or the features contain local features and the position of the image region over which the local features are computed is used to associate the features with the labels (based on proximity).

A person classifier 256 uses the modified features 254 and a identity of the person of interest 252 to determine a digital image collection subset 112 of images and videos believed to contain the person of interest. The modified features 254 includes some features having associated labels (known as labeled features). Other features (known as unlabeled features) do not have associated labels (e.g. all of the image and videos in the digital image collection 102 that were not labeled by the labeler 104). The person classifier 256 uses labeled features to classify the unlabeled features. This problem, although in practice quite difficult, is studied in the field of pattern recognition. Any classifier may by used to classify the unlabeled features. Preferably, the person classifier determines a proposed label for each of the unlabeled features and a confidence, belief, or probability associated with the proposed label. In general, classifiers assign labels to unlabeled featured by considering the similarity between a particular set of unlabeled features and labeled sets of features. With some classifiers (e.g. Gaussian Maximum Likelihood), labeled sets of features associated with a single individual person are aggregated to form a model of appearance for the individual. The digital image collection subset 112 is the collection of images and videos having an associated proposed label with a probability that exceeds a threshold T₀, where T₀ ranges from 0<=T₀<=1.0. Preferably, the digital image collection subset 112 also contains the image and videos associated with features having labels matching the identity of the person of interest 252. The images and videos of the digital image collection subset are sorted so that images and videos determined to have the highest belief of containing the person of interest appear at the top of the subset, following only the images and videos with features having labels matching the identity of the person of interest 252.

The person classifier 256 can measure the similarity between sets of features associated with two or more persons to determine the similarity of the persons, and thereby the likelihood that the persons are the same. Measuring the similarity of sets of features is accomplished by measuring the similarity of subsets of the features. For example, when the local features describe clothing, the following method is used to compare two sets of features. If the difference in image capture time is small (i.e. less than a few hours) and if the quantitative description of the clothing is similar in each of the two sets of features is similar, then the likelihood of the two sets of local features belonging to the same person is increased. If, additionally, the clothes have a very unique or distinctive pattern (e.g. a shirt of large green, red, and blue patches) for both sets of local features, then the likelihood is even greater that the associated people are the same individual.

Clothing can be represented in different ways. The color and texture representations and similarity described in U.S. Pat. No. 6,480,840 by Zhu and Mehrotra is one possible way. In another possible representation, Zhu and Mehrotra describe a method specifically intended for representing and matching patterns such as those found in textiles in U.S. Pat. No. 6,584,465. This method is color invariant and uses histograms of edge directions as features. Alternatively, features derived from the edge maps or Fourier transform coefficients of the clothing patch images can be used as features for matching. Before computing edge-based or Fourier-based features, the patches are normalized to the same size to make the frequency of edges invariant to distance of the subject from the camera/zoom. A multiplicative factor is computed which transforms the inter-ocular distance of a detected face to a standard inter-ocular distance. Since the patch size is computed from the inter-ocular distance, the clothing patch is then sub-sampled or expanded by this factor to correspond to the standard-sized face.

A uniqueness measure is computed for each clothing pattern that determines the contribution of a match or mismatch to the overall match score for persons, as shown in Table 5, where + indicates a positive contribution and − indicates a negative contribution, with the number of + or − used to indicate the strength of the contribution. The uniqueness score is computed as the sum of uniqueness of the pattern and the uniqueness of the color. The uniqueness of the pattern is proportional to the number of Fourier coefficients above a threshold in the Fourier transform of the patch. For example, a plain patch and a patch with single equally spaced stripes have 1 (dc only) and 2 coefficients respectively, and thus have low uniqueness score. The more complex the pattern, the higher the number of coefficients that will be needed to describe it, and the higher its uniqueness score. The uniqueness of color is measured by learning, from a large database of images of people, the likelihood that a particular color occurs in clothing. For example, the likelihood of a person wearing a white shirt is much greater than the likelihood of a person wearing an orange and green shirt. Alternatively, in the absence of reliable likelihood statistics, the color uniqueness is based on its saturation, since saturated colors are both rarer and also can be matched with less ambiguity. In this manner, clothing similarity or dissimilarity, as well as the uniqueness of the clothing, taken with the capture time of the images are important features for the person classifier 256 to recognize a person of interest.

Clothing uniqueness is measured by learning, from a large database of images of people, the likelihood that particular clothing appears. For example, the likelihood of a person wearing a white shirt is much greater than the likelihood of a person wearing an orange and green plaid shirt. In this manner, clothing similarity or dissimilarity, as well as the uniqueness of the clothing, taken with the capture time of the images are important features for the person classifier 256 to recognize a person of interest.

TABLE 5
The effect of clothing on likelihood of
two people being the same individual

| | |
|---|---|
| Time | Clothing Uniqueness |

| Interval | | common | rare |
|---|---|---|---|
| Same event | Match | ++ | +++ |
| | Not Match | −−− | −−− |
| Different | Match | + | +++ |
| Event | Not Match | No effect | No effect |

Table 5 shows the how the likelihood of two people is affected by using a description of clothing. When the two people are from images or videos from the same event, then the likelihood of the people being the same individual decreases (- - -) a large amount when the clothing does not match. The “same event” means that the images have only a small difference between image capture time (i.e. less than a few hours), or that they have been classified as belonging to the same event either by a user or by an algorithm such as described in U.S. Pat. No. 6,606,411. Briefly summarized, a collection of images are classified into one or more events determining one or more largest time differences of the collection of images based on time and/or date clustering of the images and separating the plurality of images into the events based on having one or more boundaries between events which one or more boundaries correspond to the one or more largest time differences.

When the clothing of two people matches and the images are from the same event, then the likelihood that the two people are the same individual depends on the uniqueness of the clothing. The more unique the clothing that matches between the two people, the greater the likelihood that the two people are the same individual.

When the two people are from images belonging to different events, a mismatch between the clothing has no effect on the likelihood that the people are the same individuals (as it is likely that people change clothing).

Preferably, the user can adjust the value of T₀ through the user interface. As the value increases, the digital image collection subset 112 contains fewer images or videos, but the likelihood that the images and videos in the digital image collection subset 112 actually do contain the person of interest increases. In this manner, the user can determine the number and accuracy of the search results.

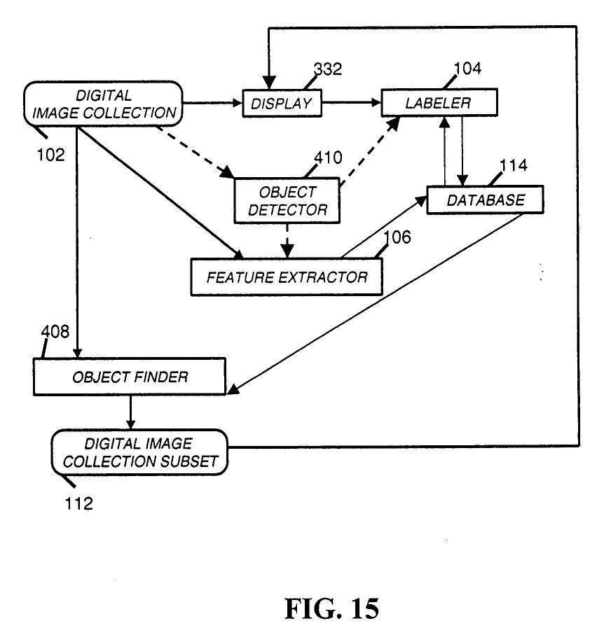

The invention can be generalized beyond recognizing people, to a general object recognition method as shown in FIG. 15, which is similar to FIG. 2. A digital image collection 102 containing objects is searched for an object of interest by a person finder 408. The digital image collection subset 112 is displayed on the display 332 for review by the human user.

The search for an object of interest is initiated by a user as follows: Images or videos of the digital image collection 102 are displayed on the display 332 and viewed by the user. The user establishes one or more labels for one or more of the images with a labeler 104. A feature extractor 106 extracts features from the digital image collection in association with the label(s) from the labeler 104. The features are stored in association with labels in a database 114. An object detector 410 can optionally be used to assist in the labeling and feature extraction. When the digital image collection subset 112 is displayed on the display 332, the user can review the results and further label the displayed images.

A label from the labeler 104 indicates that a particular image or video contains a person of interest and includes at least one of the following:

(1) the name of an object of interest in an image or video.

(2) an identifier associated with the person of interest such as a text string or identifier such as “Object A” or “Object B”.

(3) the location of the object of interest within the image or video. Preferably, the location of the object of interest is specified by coordinates of a box that surrounds the object of interest. The user can indicate the location of the object of interest by using a mouse to click on the positions of the eyes for example. When an object detector 410 detects an object, the position of the object can be highlighted to the user by, for example, circling the object on the display 332. Then the user can provide the name or identifier for the highlighted object, thereby associating the position of the object with the user provided label.

(4) an indication to search for images or videos from the image collection believed to contain the object of interest.

(5) the name or identifier of an object of interest who is not in the image. For example, the object of interest can be a person, face, car, vehicle, or animal.

Those skilled in the art will recognize that many variations may be made to the description of the present invention without significantly deviating from the scope of the present invention.

### Parts List

10 image capture
25 background areas taken together
40 general control computer
102 digital image collection
104 labeler
106 feature extractor
108 person finder
110 person detector
112 digital image collection subset
114 database
202 block
204 block
206 block
207 block
208 block
210 block
212 block
214 block
220 labeled image
222 image correctly believed to contain the person of interest
224 image incorrectly believed to contain the person of interest
226 label
228 generated label
240 local feature detector
242 global feature detector
244 focal features
246 global features
250 person identifier
252 identity of person of interest
254 modifies features
   List Cont'd
256 person classifier
260 first image
262 second image
264 person
266 person
268 person
270 face detector
272 capture time analyzer
274 detected people
282 face region
284 clothing region
286 background region
310 digital camera phone
303 flash
305 lens
311 CMOS image sensor
312 timing generator
314 image sensor array
316 A/D converter circuit
318 DRAM buffer memory
320 digital processor
322 RAM memory
324 real-time clock
325 location determiner
328 firmware memory
330 image/data memory
332 color display
334 user controls
   List Cont'd
340 audio codec
342 microphone
344 speaker
350 wireless modem
352 RF channel
358 phone network
362 dock interface
364 dock/charger
370 Internet
372 service provider
408 object finder
410 object detector
502 hair region
504 bang region
506 eyeglasses region
508 cheek region
510 long hair region
512 beard region
514 mustache region

1. A method of identifying a particular person in a digital image collection, wherein at least one of the images in the digital image collection contains more than one person, comprising:
(a) providing at least one first label for a first image in the digital image collection containing a particular person and at least one other person; wherein the first label identifies the particular person and a second label for a second image in the digital image collection that identifies the particular person;
(b) using the first and second labels to identify the particular person;
(c) determining features related to the particular person from the first image or second image or both; and
(d) using such particular features to identify another image in the digital image collection believed to contain the particular person.

2. The method of claim 1, wherein the first and second labels each include the name of the particular person or an indication that the particular person is in both the first and second images.

3. The method of claim 1, wherein there are more than two labels corresponding to different images in the digital image collection.

4. The method of claim 1, wherein a user provides the first and second labels.

5. The method of claim 1, wherein step (c) includes detecting people in the images to determine the features of the particular person.

6. The method of claim 4, wherein the location of the particular person in an image is not provided by the user.

7. The method of claim 4, wherein the location of the particular person in at least one of the images of the digital image collection is provided by the user.

8. The method of claim 1, wherein the first label includes the name of the particular person and the position of that particular person in the first image, and the second label indicates that the particular person is in the second image that includes a plurality of people.

9. The method of claim 8, wherein there are multiple labels identifying multiple different persons.

10. The method of claim 9, wherein a user provides a label identifying a particular person and location of that person in an image and the multiple labels are used to identify those images containing the particular person and analyzing the used identified person to determine the features.

11. The method of claim 10, wherein each label includes the name of the particular person.

12. The method of claim 1, further comprising:
(e) displaying image(s) believed to contain the particular person to the user; and
(f) the user viewing the displayed image(s) to verify if the particular person is contained in the displayed image(s).

13. A method of identifying a particular person in a digital image collection, wherein at least one of the images contains more than one person, comprising:
(a) providing at least one label for image(s) containing a particular person; wherein the label identifies that the image contains the particular person;
(b) determining features related to the particular person;
(c) using such particular person features and the label to identify image(s) in the collection that is believed to contain the particular person;
(d) displaying image(s) believed to contain the particular person to the user; and
(e) the user viewing the displayed image(s) to verify if the particular person is contained in the displayed image(s).

14. The method of claim 13, wherein the user providing a label when the user has verified that the particular person is contained in the displayed image.

15. The method of claim 14, wherein the determined features are updated using the user provided label.

16. The method of claim 1, wherein the features are determined from facial measurements, clothing, or eyeglasses, or combinations thereof.

17. The method of claim 13, wherein the features are determined from facial measurements, clothing, or eyeglasses, or combinations thereof.
